(19) United States
(12) Patent Application Publication
(10) Pub. No.: US 2025/0168261 A1
(43) Pub. Date: May 22, 2025

(54) METHOD, NODE AND SYSTEM FOR IMPLEMENTING AN INTERWORKING LAYER

(71) Applicant: Sony Group Corporation, Tokyo (JP)

(72) Inventors: Vivek SHARMA, Basingstoke (GB); Hideji WAKABAYASHI, Basingstoke (GB); Yassin Aden AWAD, Basingstoke (GB); Yuxin WEI, Basingstoke (GB)

(73) Assignee: Sony Group Corporation, Tokyo (JP)

(21) Appl. No.: 18/833,113

(22) PCT Filed: Jan. 20, 2023
(86) PCT No.: PCT/EP2023/051435

§ 371 Date: Jul. 25, 2024

(30) Foreign Application Priority Data
Feb. 21, 2022 (EP) 22157854.5

(51) Int. Cl. H04L 69/321; H04L 45/00

(52) U.S. Cl. CPC H04L 69/321; H04L 45/54

(57) ABSTRACT

A network node and method for operating a node in a wireless communications network involves communicating user plane data between network parts. The node uses a protocol stack with a physical layer, data link layer, and interworking layer. The interworking layer handles packets with headers and payloads, transmitting them via the data link and physical layers to other network nodes. It also receives packets from other nodes, routing them based on a routing table and packet headers. Each routing table entry corresponds to a connection between infrastructure equipment parts and user equipment associated with the communicated user data.

### BACKGROUND

### Field of Disclosure

The present disclosure relates to network nodes and methods of operating network nodes in a network of nodes providing communication between parts which form an infrastructure equipment of a wireless communications network or which node forms a part of a wireless communications network for communicating user data. The present disclosure claims the Paris convention priority of European patent application EP22157854.5 filed on 21 Feb. 2022, the contents of which are incorporated herein by reference in its entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Future wireless communications networks will be expected routinely and efficiently to support communications with an ever-increasing range of devices associated with a wider range of data traffic profiles and types than existing systems are optimised to support. For example, it is expected future wireless communications networks will be expected efficiently to support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements. In some examples the infrastructure equipment or parts of infrastructure equipment forming a wireless communications network may be located remotely from each other. Accordingly, there is a desire to provide an efficient communications technique between parts of an infrastructure of a wireless communications network where those parts may be located remotely from each other. For example, in order to improve a coverage for communications devices (user equipment etc.) the parts may be mounted or form part of satellites whereas other parts may be located on the ground.

### SUMMARY OF THE DISCLOSURE

The present disclosure can help address or mitigate at least some of the issues discussed above. Embodiments of the present technique can provide a network node and a method of operating a node in a network of nodes providing communication between parts which form an infrastructure equipment of a wireless communications network or which node forms a part of a wireless communications network. That is to say that the node may be or form part of an infrastructure equipment of a wireless communications network or the node may provide a communications path between parts of an infrastructure equipment. One example of an infrastructure equipment is a gNB of a 3GPP network such as 5G or 6G or later, so that the parts of the infrastructure equipment may be a gNB CU, a gNB DU or a TRP/remote radio head (RRH). The method comprises operating a protocol stack for receiving user plane data and transmitting user plane data, the protocol stack including a physical layer, a data link layer, and an interworking layer. The interworking layer is configured to receive packets having a format comprising a header and a payload, the payload carrying user plane data, and to transmit the packets via the data link layer and the physical layer to or more other nodes of the network. The interworking layer is configured to receive packets from one or more other nodes via the data link layer and the physical layer, the received packets having the format comprising the header and the payload carrying user plane data. The interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment and a user equipment associated with the user data being communicated.

Example embodiments can provide an arrangement in which an interworking layer is formed in a protocol stack operated by a node in a network of nodes for transporting user data. The interworking layer uses a routing table having an index which identifies both routes via the network and the user equipment for which the user data is being communicated to or received from the user data so that parts of an infrastructure equipment of a wireless communications network can be located remotely. By using an index in the packet header to identify a source, a destination and a user equipment associated with the user plane data, and efficient communication protocol can be established for a network of nodes.

Example embodiments may also include a node operating a protocol stack for a control plane data for controlling the user plane, the protocol stack for the control plane including the physical layer, the data link layer, and an interworking control layer, the interworking control layer being configured to generate the index for each entry in the routing table of the interworking layer.

Respective aspects and features of the present disclosure are defined in the appended claims and include a node forming part of a network of nodes for providing communication between parts which form an infrastructure equipment of a wireless communications network or which node forms a part of a wireless communications network.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a new radio access technology (RAT) wireless communications system which may be configured to operate in accordance with certain embodiments of the present disclosure;

FIG. 2 is a schematic block diagram of an example infrastructure equipment and communications device which may be configured to operate in accordance with certain embodiments of the present disclosure;

FIG. 3a is a representation of a gNB DU and a gNB CU communicating via an F1 interface; FIG. 3b is a schematic representation of a protocol stack operated respectively by the gNB DU and gNB CU shown in FIG. 3a for communicating control plane data; and FIG. 3c is a schematic representation of a protocol stack operated respectively by the gNB DU and gNB CU shown in FIG. 3a for communicating user plane data;

FIG. 4 is an illustrative representation of a plurality of parts of infrastructure equipment forming a wireless communications network in which some parts of the infrastructure equipment are located in satellites above the Earth and other parts may be located on the ground of the Earth;

FIG. 5 is an illustrative representation of a network of nodes in which user data is communicated between the nodes using an optical communications protocol such as an All-Photonic Network (APN) and in which a logical interface for communicating user data between a CU-UP a gNB DU, which together form a gNB of a wireless communications network is formed by the network nodes according to an example embodiment;

FIG. 6a is a representation of a gNB DU and a gNB CU communicating via an F1 interface forming the logical interface between the gNB CU and gNB DU shown in FIG. 5; FIG. 6b is a schematic representation of a protocol stack operated by nodes of the network of nodes of FIG. 5 to form the logical interface between the gNB DU and the gNB CU shown in FIG. 6a for communicating control plane data; and FIG. 6c is a schematic representation of a protocol stack operated by nodes of the network of nodes of FIG. 5 to form the logical interface between the gNB DU and the gNB CU shown in FIG. 6a for communicating user plane data; and

FIG. 7 is an illustrative representation of a packet which is used to carry user data by an interworking layer shown in FIGS. 6c according to example embodiments of the present technique.

### DETAILED DESCRIPTION OF THE EMBODIMENTS

### New Radio Access Technology (5G)

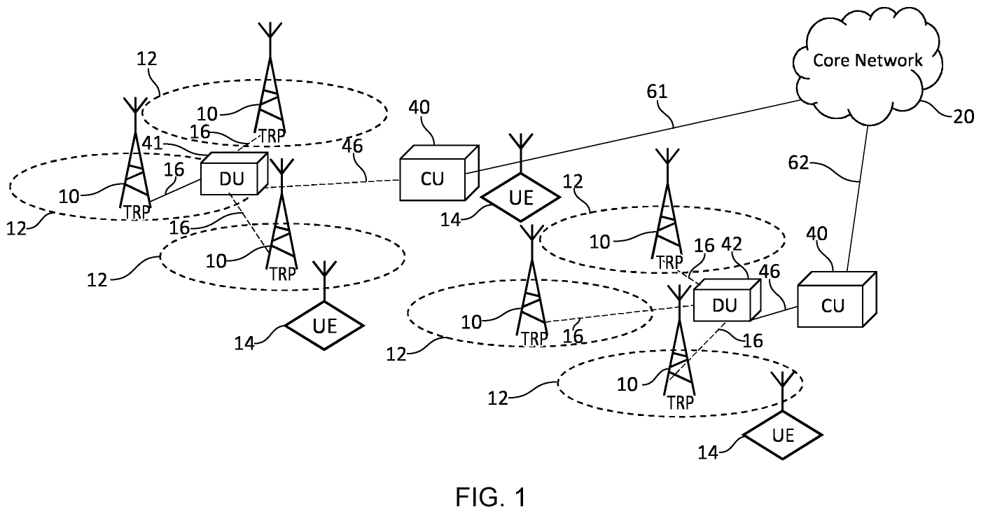

An example configuration of a wireless communications network which uses some of the terminology proposed for and used in NR and 5G is shown in FIG. 1. In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

As will be appreciated by those acquainted with the wireless communications network according to 5G standard shown in FIG. 1, the CU 40, DU 42 and TRPs 10 collectively for functions which are conventionally performed by a network base station or in accordance with 5G terminology a gNB. Embodiments of the present disclosure are particular concern with a scenario in which the functional units of the CU 40 and DU 42 and the TRP are geographically separated and therefore the communications interfaces between these components can require improvement in some scenarios described below.

The TRPs 10 of FIG. 1 may in part have a corresponding functionality to a base station or eNodeB of an LTE network. Similarly, the communications devices 14 may be referred to mobile terminals, terminals or user equipment (UE), which encompasses chip sets and have a functionality corresponding to the UE devices known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 1 within the coverage area of the first communication cell 12. This communications device 14 may thus exchange signalling with the first CU 40 in the first communication cell 12 via one of the distributed units/TRPs 10 associated with the first communication cell 12.

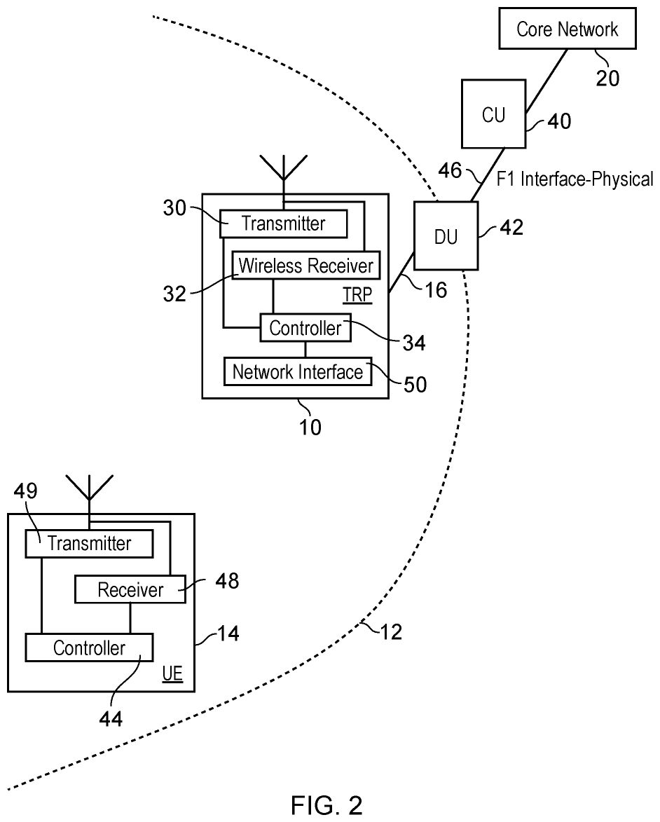

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

FIG. 2 provides a more detailed diagram of some of the components of the network shown in FIG. 1, with an indication of hardware components. In FIG. 2, a TRP 10 as shown in FIG. 1 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 2, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

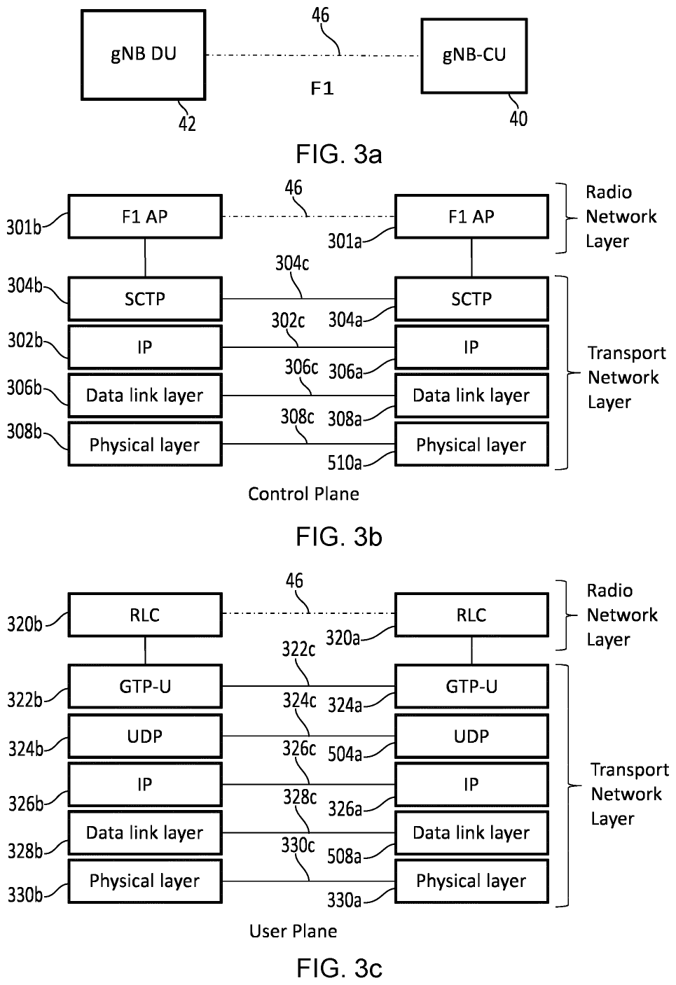

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 2, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

As indicated above example embodiments can provide an improvement in a connectivity between components which form the functionality of a gNB according to the 5G architecture presented in FIG. 1. In particular embodiments include an all photonic network which can be used to communicate user plane data between elements such as a DU, CU and TRP/Radiohead (RH) in order to provide an efficient and cost-effective communication between these elements. In order to appreciate this example embodiments, a protocol stack for forming a conventional F1 interface shown in FIGS. 1 and 2 will be explained with reference to FIG. 3.

In respect of a protocol stack, FIG. 3 provides an illustration of processing performed by the elements shown in FIGS. 1 and 2 which form the packet data communications path 46 between the gNB-DU 42 and the gNB-CU 40 via the F1 interface 46. Control plane communications are considered separately to user plane data although in practice they form the same interface and are processed and transmitted by the same hardware equipment. As shown in FIG. 3a communication is formed between the gNB DU 42 and a gNB CU 40 for the F1 interface 46. However, the control plane protocol stack to form this interface is shown in FIG. 3B, and the user plane protocol stack for communicating the user data between the gNB-CU 40 and gNB-DU 42 is shown in FIG. 3C. As shown in FIG. 3B at the radio network layer, the control plane is formed by F1 APs 301a in the gNB-CU and by F1 Application Protocols (APs) 301b in the gNB DU 42. As will be understood by those acquainted with the 5G Architecture, communication between a gNB-CU and a gNB DU by IPV 6 or IPv4 Internet protocols as specified in 3 GPP TS 138 472-V15.2.0. This is shown in FIG. 3B as an IP layer in the gNB-CU 302a and in the gNB-DU 302b forming an IP communication interface 302c. A Stream Control Transmission Protocol (SCTP) layer of the protocol stack 304a, 304b, 304c controls end to end communication via the IP layer 302 including flow control and quality of service. The IP data is communicated between the gNB DU and gNB CU via logical data link layer 306a, 306b, 306c and the physical layer 308a, 308b, 308c.

In the user plane, the radio network layer is formed by Radio Link Control (RLC) layer 320a, 320b to form the F1 interface for communicating use plane data 46. The protocol stack in the transport layer comprises a GPRS Tunnelling Protocol for user plane data (GTP-U) 322a, 322b, 322c, which controls communication of user plane data for roaming and home subscribers via a UDP layer 324a, 324b, 324c which controls communication of user plane data via an IP layer 326a, 326b, 326c. As with the control plane, the IP data is communicated between the gNB DU and gNB CU via logical data link layer 328a, 328b, 328c and the physical layer 330a, 330b, 330c.

### Deployment of Network Elements as a Non-Terrestrial Network (NTN)

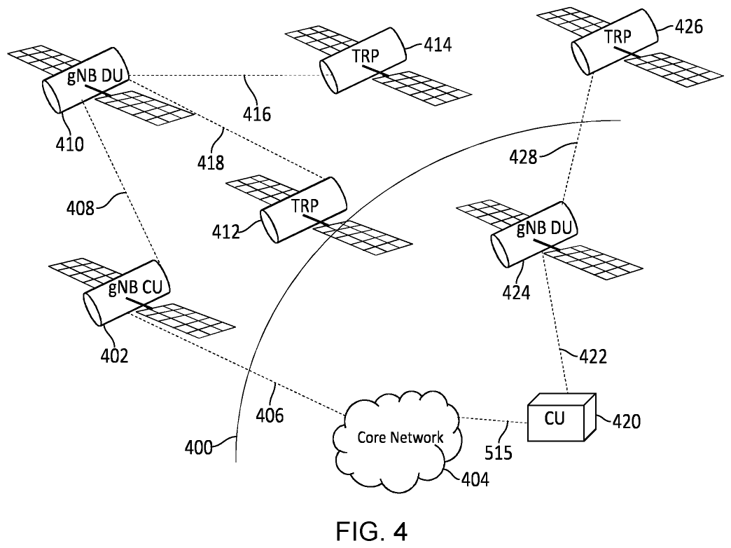

An example deployment of a 5G wireless communications network which may be used to improve coverage in some examples is a NR Non-Terrestrial Network (NTN), in which multiple satellites in orbit are used for LEO/MEO deployment with a transparent mode of operation. In transparent mode, the satellite is a bent pipe carrying RF signals and the rest of gNB functionality resides on the earth. However, there is an increased interest in regenerative satellites whereby the gNB or a part a gNB functionality resides in the satellite. The satellite could therefore carry a complete gNB functionality or each satellite could carry different gNB functionalities such as a CU, a DU or a TRP/Remote Radiohead (RRH). An example is illustrated in FIG. 4.

In FIG. 4, a plurality of satellites 402, 410, 412, 414, 424, 426, are shown in orbit around the Earth 402 in which each satellite includes certain functionality of a gNB. For example, a first satellite 402 includes the functionality of a CU and connects to the core network 404 on the ground by an Earth to satellite link 404. The first satellite carrying the gNB CU 402 is connected via F1 interface 408 to a second satellite carrying a gNB DU 410 which in turn is connected to two satellites carrying TRP's or RRH's 412, 414 via communications links 416, 418. A further example is shown in which CU 420 is located on the Earth's surface 400 and connected via an Earth to satellite link 422 to a gNB DU carried by satellite 424. The satellite 424 carrying the gNB DU is connected to a satellite 426 carrying a TRP via a communications link 428.

Once gNB functionality is on-board a satellite then Inter Satellite Links (ISL) 408, 416, 418, 428 are needed to carry different interfaces and protocols. In some examples, ISLs 408, 416, 418, 428 are transported at the physical layer using optical lasers. Furthermore, it would be desirable to provide an arrangement in which the transport of data via such optical links utilises efficient techniques which minimise or reduce a complexity of any protocol stack on each of the satellites. With such an architecture, it may or may not be a possibility to connect two satellites directly i.e. peer to peer link, or which may go through zero, one or more satellites.

In a similar example, IOWN (Innovative Optical and Wireless Network) (iowngf.org), which can use an All-Photonic Network (APN) which is intended to provide high-speed, ultra-reliable and low latency communications paths using optical data transportation. However, what is needed is an efficient communications technique or protocol to communicate via the optical network between different elements of a gNB mounted on a satellite.

Example embodiments can provide a node in a network of nodes providing communication between parts which form an infrastructure equipment of a wireless communications network or which node forms a part of a wireless communications network. For example, the node may be a CU or a DU which together form a gNB of a wireless communications network. As indicated in the above explanation, or one both of the CU or the DU may be located on satellites so that the network of nodes provides interconnection of these infrastructure parts using for example an APN or ISL. The node operates a protocol stack for receiving user plane data and transmitting user plane data, the protocol stack including a physical layer, a data link layer, and an interworking layer. The interworking layer is referred to in the following explanation of example embodiments as a gNB interworking layer although it will be appreciated that this is just an example and the interworking layer may form a connection for other parts of an infrastructure equipment or indeed a node forming part of the network of nodes which interconnects parts of an infrastructure equipment. The interworking layer is configured to receive packets having a format comprising a header and a payload, the payload carrying user plane data, and to transmit the packets via the data link layer and the physical layer to or more other nodes of the network. The interworking layer is configured to receive packets from one or more other nodes via the data link layer and the physical layer, the received packets having the format comprising the header and the payload carrying user plane data. The interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment.

Example embodiments can provide an arrangement in which the gNB interworking layer is formed for transporting user data and controls routing of the user plane data via a network or between interworking functions using a configured index to identify source and destination of the user data via the network.

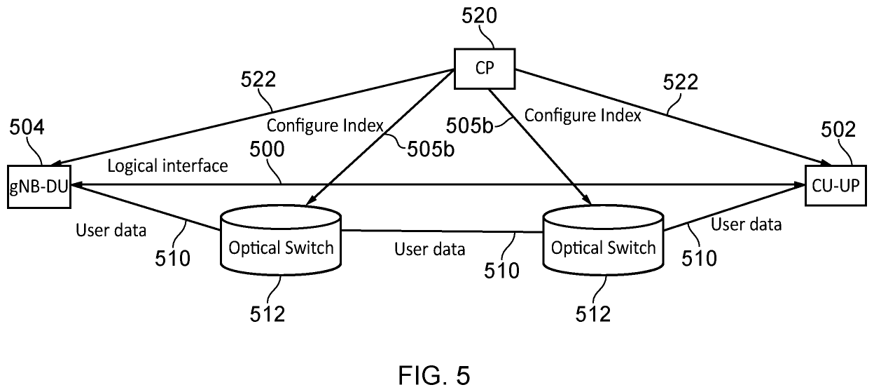

An example is shown in FIG. 5 in which an optical APN is formed. In FIG. 5, a logical communications link 500 providing a logical interface between CU providing user plane data (CU-UP) 502 is connected via the logical interface 500 to a gNB-DU 504. The logical interface 500 is formed by physical transport links 510 for the user plane data via optical switches 512. Each node therefore includes a communications interface forming part of a physical layer for transmitting user plane data via the physical transport links 510 to one or more other nodes of the network and for receiving user plane data from the one or more other nodes of the network. As will be appreciated in order to implement a physical transmission of the user plane data, via the physical data links 510, a layer in a protocol stack for transmitting data between the CU-UP 502 and the gNB-DU 504 must be formed which in the following description is referred to as interworking layer because in one example this protocol layer provides interworking between functions of a gNB. In order to configure and to control the interworking layer, a control plane element 520 controls the interworking layer in the protocol stack in each of the physical nodes of physical transmission paths, which are the CU-UP 502 and the gNB-DU 504 and the optical switches 512. Thus the CU-UP 502 and the gNB-DU 504 and the optical switches 512 according to example embodiments. The control by the control plane 502 of each of the physical nodes along the transmission path is represented by arrows 522. As will be appreciated from the above explanation, each of the physical links 510 transmitting user plane data may be formed from an ISL in which the F1 interface 500 could be an interface between two satellites via another set of satellites (DU-DU interface) or between a satellite and earth station (CU-DU interface).

According to one example, a centralised entity (CU) of a gNB may connect to different lower layer processing resources (DU) at geographically distant locations or satellites. DUs may further connect to TRPs/RRHs. DUs may not be centralised because of processing delay and bandwidth requirements between RRH and DU.

In the example shown in FIG. 5, the CP entity 520 is configured to establish an end to end path between a gNB-CU and gNB-DU via two optical switches 512. If the physical communication or transport links are formed by ISL 510, a satellite in the path connecting two peer satellites could host one of the optical switches 512. CP 520 is configured to communicate user plane packets from one peer to another.

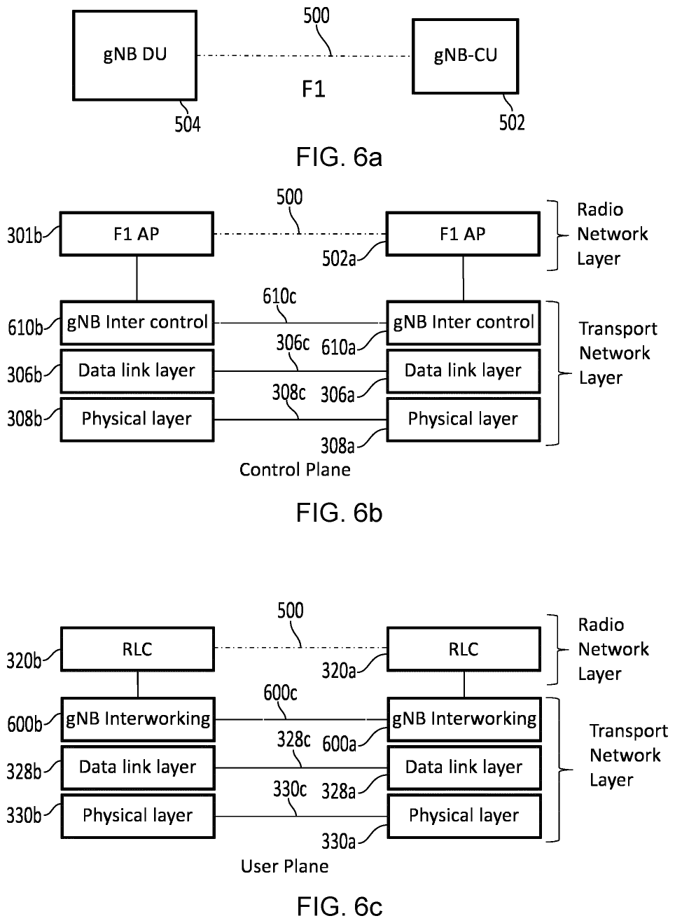

According to example embodiments, the network shown in FIG. 5 is implemented by providing an adapted protocol stack which includes the interworking layer as illustrated in FIGS. 6a, 6b and 6c which corresponds to the diagrams shown in FIGS. 3a, 3b and 3 but adapted to illustrate example embodiments. In FIG. 6a, the gNB CU 502 and gNB DU 504 are shown to be connected by logical interface 500 for establishing an F1 interface corresponding to the example shown in FIG. 5. In FIG. 6b and FIG. 6c a protocol stack is shown for the control plane and user plane data respectively. The protocol stacks for the user plane and the control plane of FIGS. 6c and 6b correspond respectively to those shown in FIGS. 3c and 3b, and so only the differences with respect to those established protocol stacks will be described for brevity and conciseness. As shown in FIG. 6c the user plane protocol stack includes a gNB interworking layer 600a, 600b, 600c which is on top of the data link layer 328a, 328b, 328c and the physical layer 330a, 330b, 330c. The RLC service data units (SDU) are therefore transmitted by the gNB interworking layer, which replaces the GTP-U layer 322a, 322b, 322c, the UDP later 324a, 324b, 324c and the IP layer 326a, 326b, 326c shown in FIG. 3c. The user plane data is therefore being transmitted as RLC SDUs via the protocol stack shown in FIG. 6C in which the gNB interworking layer 600 is used to transmit data received from the RRC layer between the gNB DU 504 gNB CU 502. Correspondingly, the control plane shown in FIG. 6b provides a control plane layer for the gNB interworking control layer 610a, 610b, 610c which controls the user plane gNB interworking layer by configuring the respective network nodes 502, 504, 522 to control transmission of the user plane data under influence of the F1 AP layer 301a, 301b, 500 via the data link layer 306a, 306b, 306c and physical layers 308a, 308b, 308c.

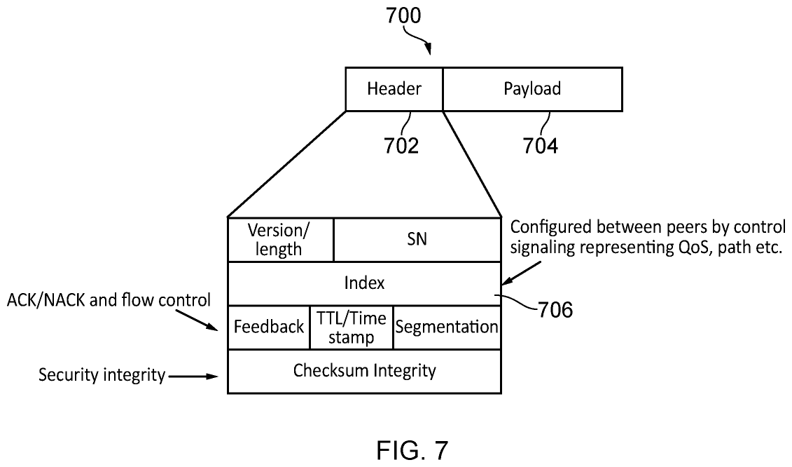

According to the example shown in FIG. 6c, RLC SDU may be transferred to an optical network in order to allow the optical networks to provide end to end communication between a CU and a DU from FIGS. 5 and 6. This communication of user plane data is achieved by a gNB interworking protocol layer 600a, 600b, 600c which is provided on top of optical switches forming the data link layer and the physical layer. This interworking protocol layer can be established between termination points i.e. between a DU and CU or between DU and another DU and can hide a hop by hop configuration of existing optical switches. A packet form according to example embodiments is shown in FIG. 7.

As shown in FIG. 7, a representation of the packet 700 is shown with a header 702 and a payload 704, which carries user data. The interworking protocol layer 600 is configured to receive and to transmit the user data with a data header 702 for transporting data via the data link layer 328 and the physical layer 330. The header 702 includes an index for a routing table which has an entry in the routing table for that index value for each UE identifier (ID) and source and destination identifiers (IDs) or addresses of network nodes. That is to say that the index will point to a combination of source ID or address, destination ID or address and further fields, for example those shown in FIG. 7 and the table below. Further fields, which can be included in the new header can be:
QoS management and paths establishment
Flow control
Link discovery and setup
ACK/NACK feedback, if needed
Security (as IPSec cannot be used because IP layer is not present) including keys, ciphering and integrity protection algorithms and keys

These fields are required because GTP, UDP and IP layers from a conventional F1 protocol stack are replaced by the gNB interworking layer and so this functionality is provided by the gNB interworking layer. To achieve this replacement of these protocol layers, the header is formed according to example embodiments as shown in FIG. 7. According to example embodiments, the header 702 includes an index field 706. The index field 706 should be configured between peer nodes by using control plane signalling, by the interworking control layer 610. The index 706 in one example, can provide an index of a configuration in a node's routing table. An APN routing table may have more parameters and more dynamically configured as compared to an IP router routing table. One example of APN routing table and index is as shown below:

TABLE 1
Example of routing table

| | | QoS | | |
|---|---|---|---|---|
| | | parameter set | | |
| | Destination | (TFlow | Security | |
| Source ID | ID | Template) | parameters | Index |
| A | B | X | Ciph = on | 1 |
| A | B | Y | Ciph = off | 2 |

There may be additional fields in the table and one such example of an additional field is a field to support mobility. Mobility refers to both UE mobility and application mobility. A UE's mobility is due to user mobility. An application program's mobility, on the other hand, is a mobility of a place of software application/cloud instance, which is transferred from a current server/cloud to a server/cloud/edge computing nearer the user. As a result, a communication path is shortened, and a latency is reduced. An example of application's mobility is when an application has moved from an edge of the network to a centralised place in the network. Alternatively, an application is moved between different clients at the edge of the network whereby each client is physically residing at or closer to the gNB for example. In this case, a separate index value may be configured in the routing table.

For UE mobility, according to example embodiments a table in each of the network nodes may include a UE ID and a gNB ID mapping. In one of the embodiments, the index may contain a gNB ID and UE ID. A change in gNB ID for the same UE_ID may indicate a handover (HO). A UE-ID has to be unique and therefore a field representing the UE ID may be large in size. A field representing a gNB ID is also expected to be large, leading to a requirement to support a large number of indexes, each representing a mapping between each UE and each gNB and hence the index could be a few octets long. In another embodiment, the index also contains the HO configuration i.e. for conditional HO or conditional PSCell change or addition, each set of configuration may be linked to a unique index value.

According to one example, a UE in a source cell may have index value configured as say 40 and when the UE moves to a target cell the index value related to this configuration is 41. So, if an upstream node received a packet with index 40 then the UE is with the source cell. But if it receives a packet with index 41 then it has moved to target cell. This pre-configuration is similar to conditional handover over the radio where a UE is configured with one or more target cells in advance and then the UE moves to one of these cells when a trigger criteria is met. Embodiments can therefore provide a radio procedure for configuring different links/paths between source and target DU and CU or source/target TRP to DU or source/target CU to core network.

For application mobility, the termination point (edge or central server) is also added to the routing table. So according to some embodiments, a distinct value of index indicates a separate end to end termination point per application and each application may have a different termination point. So there should be a separate entry in the routing table and a new unique index value per application and per application termination point. This is because, for example, a UE may be running several application programs, each providing a different service to a user of the UE. Accordingly, each index in the table identifies a different termination point for a packet being communicated via a node, the termination point being in one example an application programme being executed by a UE to provide a service to a UE.

The index 706 according to example embodiments, can provide multiple termination points within the same node, which may be for example a gNB. For example, a gNB ID may be allocated to a node and another identifier may be associated with the gNB ID to allow different termination points within the gNB. This different ID could be a hardware ID e.g. MAC ID of a board/card, so that this MAC ID may also be added to the routing table. This is currently done by assigning multiple IP addresses to a node in IP networks. For an APN, the index value 706 may be linked to a termination point in the node. This can be used to allow load balancing on hardware because for example one processor can handle a certain number of connections. In some examples, an index may be per UE ID per gNB ID and termination point ID. While comparing this mechanism to MPLS label switching, the main difference is that a Multi-protocol label switching (MPLS) label is mainly analysed by switches and routers on the path and not used for end node load balancing and determining termination points.

### Other Fields in the APN Header 702 are:

Version/Length: Version will allow future extension of the header formats. Length will indicate the header length.

SN: Sequence Number assigned to each packet. SN value may be the same as an RLC SN between gNB DU and CU because each RLC PDU will have its own SN. But if this new layer is used between RRH and DU then SN value is needed.

Feedback: indicate ACK/NACK and flow control. For RLC PDUs, this field may not be needed because RLC ARQ may be used for RLC-AM mode. If feedback is needed when e.g. RLC-UM mode is configured then this field in new header format will be used. This may also be used for flow control.

TTL/Timestamp: it is like Time To Live field in IP header. But it may additionally indicate the timestamp for Time Sensitive Networking (TSN)

Segmentation: related to segmentation/concatenation. For F1 interface, RLC segmentation/concatenation may be enough if APN is able to support the same packet size as RLC PDU size. There may be a need for concatenation of RLC PDUs to reduce packet header field overheads without compromising latency.

Checksum integrity: CRC/integrity checksum of header fields.

F1 is discussed above as one example interface, which may be supported by an ISL. In other examples an interface can be between DUs whereby a DU is hosted on a satellite. In this case a CU may reside on earth station. So, the interface design is generic and should apply to any interface between different entities of a gNB or between gNB CU and core network. There is more freedom to deploy such protocol stack (free from IP) in an internal network, be it ISL or within a wireless communications network.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a node in a network of nodes providing communication between parts which form an infrastructure equipment of a wireless communications network or which node forms a part of a wireless communications network, the method comprising
   operating a protocol stack for receiving user plane data and transmitting user plane data, the protocol stack including a physical layer, a data link layer, and an interworking layer,
   the interworking layer being configured to receive packets having a format comprising a header and a payload, the payload carrying user plane data, and to transmit the packets via the data link layer and the physical layer to or more other nodes of the network, and
   the interworking layer is configured to receive packets from one or more other nodes via the data link layer and the physical layer, the received packets having the format comprising the header and the payload carrying user plane data, wherein the interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment and a user equipment associated with the user data being communicated.
Paragraph 2. A method according to paragraph 1, the method comprising
   operating a protocol stack for a control plane data for controlling the user plane, the protocol stack for the control plane including the physical layer, the data link layer, and an interworking control layer, and
   the interworking control layer being configured to generate the index for each entry in the routing table of the interworking layer.
Paragraph 3. A method according to paragraphs 1 or 2, wherein the routing table includes an entry for each index, each index representing a unique identifier of a user equipment, UE, a source address in the network of nodes and a destination address in the network of nodes, and the header of the packets includes the index.
Paragraph 4. A method according to paragraph 3, wherein the destination address or the source address of a plurality of indexes in the routing table can identify a different termination point within the same network node.
Paragraph 5. A method according to paragraph 4, wherein the destination address or the source address identifies one of medium access control, MAC, identifier or a hardware identifier.
Paragraph 6. A method according to paragraph 3, wherein the destination address or the source address of each index in the routing table identifies a user equipment or an application program being executed by the user equipment.
Paragraph 7. A method according to paragraph 3, wherein different indexes within the routing table identify the destination address or the source address of a different application program being executed by the same user equipment.
Paragraph 8. A method according to any of paragraphs 3 to 7, wherein each index in the routing table includes an indication of one or more of a quality of service, QoS, management and paths establishment, a flow control, a link discovery and setup procedure, an acknowledgement or negative acknowledgement, ACK/NACK feedback, security information including at least one encryption key, an indication is to whether ciphering is applied or not, and an indication of an integrity protection algorithm and an associated key.
Paragraph 9. A method according to any of paragraphs 3 to 8, wherein each index in the routing table includes an indication of one of a mobility of a user equipment and/or a mobility of an application program executed by a user equipment within the network of nodes.
Paragraph 10. A method according to paragraph 9, wherein the mobility of the application program includes whether the application program has moved from an edge of the network of nodes to a centre of the network of nodes.
Paragraph 11. A method according to paragraph 10, the mobility of the application program includes the application program being moved from a server attached to the network to a cloud server.
Paragraph 12. A method according to any of paragraphs 3 to 11, wherein the routing table includes for each index an identification of an infrastructure equipment via which a UE for that entry has selected for communication to the wireless communications network or receive data from the wireless communications network, the unique identifier of the UE and the unique identifier of the infrastructure equipment representing a UE to infrastructure mapping.
Paragraph 13. A method according to paragraph 12, wherein a change of the UE to infrastructure mapping represents a handover of the UE from one infrastructure equipment to another in the wireless communications network and corresponds with a change in one index of the routing table to another according to a change from the one infrastructure equipment to the other infrastructure equipment.
Paragraph 14. A method according to any of paragraphs 1 to 13, wherein the node is a part of an infrastructure equipment of a wireless communications network and the protocol stack for receiving user plane data and transmitting user plane data includes a radio link control layer, the radio link control layer being configured to receive the user plane data and to transmit the user plane data in service data units via the interworking layer,
   the interworking layer being configured to receive the service data units from the radio link control layer and to form the service data units into the packets for transmission, the payload of the packets carrying one or more of the service data units or part thereof, and
   the interworking layer being configured to receive the packets from the one or more other nodes via the data link layer and the physical layer, the received the payload of the packets carrying one or more of the service data units or part thereof for the radio link control layer and to form the service data units from the received packets and to pass the service data units to the radio link layer.
Paragraph 15. A method according to paragraph 14, wherein the source address or the destination address of the packets is the address of the part of the infrastructure equipment.
Paragraph 16. A method according to paragraph 14 or 15, wherein the part of the infrastructure equipment is a central unit of the wireless communications network.
Paragraph 17. A method according to paragraph 16, wherein the central unit is located on the Earth. Paragraph 18. A method according to paragraph 16, wherein the central unit forms part of a satellite in orbit above the Earth.
Paragraph 19. A method according to paragraph 14 or 15, wherein the part of the infrastructure equipment is a distributed unit of the wireless communications network.
Paragraph 20. A method according to paragraph 19, wherein the distributed unit forms part of a satellite in orbit above the Earth.
Paragraph 21. A method according to any of paragraphs 16 to 20, wherein the infrastructure equipment is a gNB of a 3GPP 5G wireless communications network.
Paragraph 22. A method according to any of paragraphs 1 to 21, wherein the physical layer is formed at least in part by an optical communications device.
Paragraph 23. A method according to paragraph 22, wherein the network of nodes is formed by an all-photonic network.
Paragraph 24. A node for forming part of a network of nodes for communicating between parts which form an infrastructure equipment of a wireless communications network or which node forms a part of a wireless communications network, the node comprising
   a communications interface forming part of a physical layer for transmitting user plane data to one or more other nodes of the network and for receiving user plane data from the one or more other nodes of the network,
   a processor and a storage medium for storing computer executable code, which when executed by the processor performs operations comprising
   operating a protocol stack for receiving the user plane data and transmitting the user plane data, the protocol stack including the physical layer, a data link layer, and an interworking layer,
   the interworking layer being configured to receive packets having a format comprising a header and a payload, the payload carrying user plane data, and to transmit the packets via the data link layer and the physical layer to or more other nodes of the network, and
   the interworking layer is configured to receive packets from one or more other nodes via the data link layer and the physical layer, the received packets having the format comprising the header and the payload carrying user plane data, wherein the interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment and a user equipment associated with the user data being communicated.
Paragraph 25. A node according to paragraph 24, wherein the computer executable code when executed by the processor performs operations including
   operating a protocol stack for a control plane data for controlling the user plane, the protocol stack for the control plane including the physical layer, the data link layer, and an interworking control layer, and
   the interworking control layer is configured to generate the index for each entry in the routing table of the interworking layer.
Paragraph 26. A node according to paragraphs 24 or 25, wherein the routing table includes an entry for each index, each index representing a unique identifier of a user equipment, UE, a source address in the network of nodes and a destination address in the network of nodes, and the header of the packets includes the index.
Paragraph 27. A node according to paragraph 24, wherein the destination address or the source address of a plurality of indexes in the routing table can identify a different termination point within the same network node.
Paragraph 28. A node according to paragraph 24, wherein the destination address or the source address identifies one of medium access control, MAC, identifier or a hardware identifier.
Paragraph 29. A node according to paragraph 24, wherein the destination address or the source address of each index in the routing table identifies a user equipment or an application program being executed by the user equipment.
Paragraph 30. A node according to paragraph 24, wherein different indices within the routing table identify the destination address or the source address of a different application program being executed by the same user equipment.
Paragraph 31. A node according to any of paragraphs 24 to 30, wherein each index in the routing table includes an indication of one or more of a quality of service, QoS, management and paths establishment, a flow control, a link discovery and setup procedure, an acknowledgement or negative acknowledgement, ACK/NACK feedback, security information including at least one encryption key, an indication is to whether ciphering is applied or not, and an indication of an integrity protection algorithm and an associated key.
Paragraph 32. A node according to any of paragraphs 24 to 31, wherein each index in the routing table includes an indication of one of a mobility of a user equipment and/or a mobility of an application program executed by a user equipment within the network of nodes.
Paragraph 33. A node according to any of paragraphs 24 to 32, wherein the routing table includes for each index an identification of an infrastructure equipment via which a UE for that entry has selected for communication to the wireless communications network or receive data from the wireless communications network, the unique identifier of the UE and the unique identifier of the infrastructure equipment representing a UE to infrastructure mapping.
Paragraph 34. A node according to paragraph 33, wherein a change of the UE to infrastructure mapping represents a handover of the UE from one infrastructure equipment to another in the wireless communications network and corresponds with a change in one index of the routing table to another according to a change from the one infrastructure equipment to the other infrastructure equipment.
Paragraph 35. A node according to any of paragraphs 24 to 34, wherein the node is a part of an infrastructure equipment of a wireless communications network and the protocol stack for receiving user plane data and transmitting user plane data includes a radio link control layer, the radio link control layer being configured to receive the user plane data and to transmit the user plane data in service data units via the interworking layer,
   the interworking layer being configured to receive the service data units from the radio link control layer and to form the service data units into the packets for transmission, the payload of the packets carrying one or more of the service data units or part thereof, and
   the interworking layer being configured to receive the packets from the one or more other nodes via the data link layer and the physical layer, the received the payload of the packets carrying one or more of the service data units or part thereof for the radio link control layer and to form the service data units from the received packets and to pass the service data units to the radio link layer.
Paragraph 36. A node according to paragraph 35, wherein the source address or the destination address of the packets is the address of the part of the infrastructure equipment.
Paragraph 37. A node according to paragraph 35 or 36, wherein the part of the infrastructure equipment is a central unit of the wireless communications network.
Paragraph 38. A node according to paragraph 37, wherein the central unit is located on the Earth. Paragraph 39. A node according to paragraph 37, wherein the central unit forms part of a satellite in orbit above the Earth.
Paragraph 40. A node according to paragraph 35 or 36, wherein the part of the infrastructure equipment is a distributed unit of the wireless communications network.
Paragraph 41. A node according to paragraph 40, wherein the distributed unit forms part of a satellite in orbit above the Earth.
Paragraph 42. A node according to any of paragraphs 35 to 41, wherein the infrastructure equipment is a gNB of a 3GPP 5G wireless communications network.
Paragraph 43. A node according to any of paragraphs 24 to 42, wherein the physical layer is formed at least in part by an optical communications device.
Paragraph 44. A node according to paragraph 43, wherein the network of nodes is formed by an all-photonic network.
Paragraph 45. A wireless communications network including an infrastructure equipment, wherein user plane data is communicated between the infrastructure equipment or different parts which form one or more of the infrastructure equipment via a network of nodes, each node of the network of nodes comprising
   a communications interface forming part of a physical layer for transmitting user plane data to one or more other nodes of the network and for receiving user plane data from the one or more other nodes of the network via physical transport links,
   a processor and a storage medium for storing computer executable code, which when executed by the processor performs operations comprising
   operating a protocol stack for receiving the user plane data and transmitting the user plane data, the protocol stack including the physical layer, a data link layer, and an interworking layer,
   the interworking layer being configured to receive packets having a format comprising a header and a payload, the payload carrying user plane data, and to transmit the packets via the data link layer and the physical layer to or more other nodes of the network, and
   the interworking layer is configured to receive packets from one or more other nodes via the data link layer and the physical layer, the received packets having the format comprising the header and the payload carrying user plane data, wherein the interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment and a user equipment associated with the user data being communicated.
46. A network according to paragraph 45, wherein the computer executable code when executed by the processor performs operations including
   operating a protocol stack for a control plane data for controlling the user plane, the protocol stack for the control plane including the physical layer, the data link layer, and an interworking control layer, and
   the interworking control layer is configured to generate the index for each entry in the routing table of the interworking layer.
Paragraph 47. A node according to paragraphs 45 or 46, wherein the routing table includes an entry for each index, each index representing a unique identifier of a user equipment, UE, a source address in the network of nodes and a destination address in the network of nodes, and the header of the packets includes the index.
Paragraph 48. A network according to paragraph 47, wherein the destination address or the source address of a plurality of indexes in the routing table can identify a different termination point within the same network node.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR 38.470.

1. A method of operating a node in a network of nodes providing communication between parts which form an infrastructure equipment of a wireless communications network or which node forms a part of a wireless communications network, the method comprising
operating a protocol stack for receiving user plane data and transmitting user plane data, the protocol stack including a physical layer, a data link layer, and an interworking layer,
the interworking layer being configured to receive packets having a format comprising a header and a payload, the payload carrying user plane data, and to transmit the packets via the data link layer and the physical layer to or more other nodes of the network, and
the interworking layer is configured to receive packets from one or more other nodes via the data link layer and the physical layer, the received packets having the format comprising the header and the payload carrying user plane data, wherein the interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment and a user equipment associated with the user data being communicated.

2. A method according to claim 1, the method comprising
operating a protocol stack for a control plane data for controlling the user plane, the protocol stack for the control plane including the physical layer, the data link layer, and an interworking control layer, and
the interworking control layer being configured to generate the index for each entry in the routing table of the interworking layer.

3. A method according to claim 1, wherein the routing table includes an entry for each index, each index representing a unique identifier of a user equipment, UE, a source address in the network of nodes and a destination address in the network of nodes, and the header of the packets includes the index.

4. A method according to claim 3, wherein the destination address or the source address of a plurality of indexes in the routing table can identify a different termination point within the same network node.

5. A method according to claim 4, wherein the destination address or the source address identifies one of medium access control, MAC, identifier or a hardware identifier.

6. A method according to claim 3, wherein the destination address or the source address of each index in the routing table identifies a user equipment or an application program being executed by the user equipment.

7. A method according to claim 3, wherein different indexes within the routing table identify the destination address or the source address of a different application program being executed by the same user equipment.

8. A method according to claim 3, wherein each index in the routing table includes an indication of one or more of a quality of service, QoS, management and paths establishment, a flow control, a link discovery and setup procedure, an acknowledgement or negative acknowledgement, ACK/NACK feedback, security information including at least one encryption key, an indication is to whether ciphering is applied or not, and an indication of an integrity protection algorithm and an associated key.

9. A method according to claim 3, wherein each index in the routing table includes an indication of one of a mobility of a user equipment and/or a mobility of an application program executed by a user equipment within the network of nodes.

10.-23. (canceled)

24. A node for forming part of a network of nodes for communicating between parts which form an infrastructure equipment of a wireless communications network or which node forms a part of a wireless communications network, the node comprising
a communications interface forming part of a physical layer for transmitting user plane data to one or more other nodes of the network and for receiving user plane data from the one or more other nodes of the network,
a processor and a storage medium for storing computer executable code, which when executed by the processor performs operations comprising
operating a protocol stack for receiving the user plane data and transmitting the user plane data, the protocol stack including the physical layer, a data link layer, and an interworking layer,
the interworking layer being configured to receive packets having a format comprising a header and a payload, the payload carrying user plane data, and to transmit the packets via the data link layer and the physical layer to or more other nodes of the network, and
the interworking layer is configured to receive packets from one or more other nodes via the data link layer and the physical layer, the received packets having the format comprising the header and the payload carrying user plane data, wherein the interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment and a user equipment associated with the user data being communicated.

25. A node according to claim 24, wherein the computer executable code when executed by the processor performs operations including
operating a protocol stack for a control plane data for controlling the user plane, the protocol stack for the control plane including the physical layer, the data link layer, and an interworking control layer, and
the interworking control layer is configured to generate the index for each entry in the routing table of the interworking layer.

26. A node according to claim 24, wherein the routing table includes an entry for each index, each index representing a unique identifier of a user equipment, UE, a source address in the network of nodes and a destination address in the network of nodes, and the header of the packets includes the index.

27. A node according to claim 24, wherein the destination address or the source address of a plurality of indexes in the routing table can identify a different termination point within the same network node.

28. A node according to claim 24, wherein the destination address or the source address identifies one of medium access control, MAC, identifier or a hardware identifier.

29. A node according to claim 24, wherein the destination address or the source address of each index in the routing table identifies a user equipment or an application program being executed by the user equipment.

30. A node according to claim 24, wherein different indices within the routing table identify the destination address or the source address of a different application program being executed by the same user equipment.

31. A node according to claim 24, wherein each index in the routing table includes an indication of one or more of a quality of service, QOS, management and paths establishment, a flow control, a link discovery and setup procedure, an acknowledgement or negative acknowledgement, ACK/NACK feedback, security information including at least one encryption key, an indication is to whether ciphering is applied or not, and an indication of an integrity protection algorithm and an associated key.

32. A node according to claim 24, wherein each index in the routing table includes an indication of one of a mobility of a user equipment and/or a mobility of an application program executed by a user equipment within the network of nodes.

33. A node according to claim 24, wherein the routing table includes for each index an identification of an infrastructure equipment via which a UE for that entry has selected for communication to the wireless communications network or receive data from the wireless communications network, the unique identifier of the UE and the unique identifier of the infrastructure equipment representing a UE to infrastructure mapping.

34.-44. (canceled)

45. A wireless communications network including an infrastructure equipment, wherein user plane data is communicated between the infrastructure equipment or different parts which form one or more of the infrastructure equipment via a network of nodes, each node of the network of nodes comprising
a communications interface forming part of a physical layer for transmitting user plane data to one or more other nodes of the network and for receiving user plane data from the one or more other nodes of the network via physical transport links,
a processor and a storage medium for storing computer executable code, which when executed by the processor performs operations comprising
operating a protocol stack for receiving the user plane data and transmitting the user plane data, the protocol stack including the physical layer, a data link layer, and an interworking layer,
the interworking layer being configured to receive packets having a format comprising a header and a payload, the payload carrying user plane data, and to transmit the packets via the data link layer and the physical layer to or more other nodes of the network, and
the interworking layer is configured to receive packets from one or more other nodes via the data link layer and the physical layer, the received packets having the format comprising the header and the payload carrying user plane data, wherein the interworking layer is configured to route the packets to and from one or more other network nodes using a routing table and the header of the packets transmitted and received via the data link layer and the physical layer to or from the one or more other nodes of the network includes an index representing a value identifying an entry in the routing table which is used by the interworking layer to transmit the packets to or to receive the packets from the one or more other nodes of the network, the entry in the table for each index identifying a connection between one part of the infrastructure equipment and another part of the infrastructure equipment and a user equipment associated with the user data being communicated.

46.-48. (canceled)
